(19) United States
(12) Patent Application Publication
(10) Pub. No.: US 2003/0091325 A1
(43) Pub. Date: May 15, 2003

(54) Device for audio and video playback

(76) Inventor: Leonardo Estevez, Rowlett, TX (US)

Correspondence Address: TEXAS INSTRUMENTS INCORPORATED, P O BOX 655474, M/S 3999, DALLAS, TX, 75265

(21) Appl. No.: 10/256,980

(22) Filed: Sep. 27, 2002

Related U.S. Application Data
(60) Provisional application No. 60/336,077, filed on Nov. 14, 2001.

(51) Int. Cl. H04N 5/76; G11B 27/00

(52) U.S. Cl. 386/46; 386/96

(57) ABSTRACT

A device for audio and video playback is operable to receive a digital video signal input or an analog video signal such as a National Television System Committee-standard (NTSC) video signal input through an input connector port of the device. The device may also receive an audio signal input through an audio input connector port. The audio and video playback device includes a storage device for storing audio and video signals in Moving Picture Experts Group-standard (MPEG) format. The audio and video playback device also includes output connector ports operable to provide audio output and video output. A central processing unit in the device receives audio and video input signals from the input connector ports, compresses the audio and video input signals into MPEG format and can store the MPEG-format signals in the storage device. The processor is also operable to retrieve and decompress stored audio and video signals from the storage device and provide output signals to output connector ports.

### TECHNICAL FIELD OF THE INVENTION

This invention relates to video information and display technology and more particularly to a portable device for audio and video playback.

### BACKGROUND OF THE INVENTION

Technological advances continue to increase the availability and capabilities of the Internet. The rising popularity of high-speed Internet connections permits consumers to download greater amounts of information in shorter periods of time. Consumers, accordingly, seek new ways to make use of the Internet in their business and personal lives. One such use is the downloading of video and audio files, which are generally saved to a personal computer for later playback. Such video files are often available in Moving Pictures Expert Group (MPEG) format, while audio files often utilize the MPEG-III (MP3) format.

Portable devices are currently on the market that permit a consumer to store and play back audio MP3 files whenever and wherever they choose to do so. To view a MPEG video file generally requires access to a personal computer. No portable devices are available to permit a consumer to store and play back video MPEG files. The size of portable video players is generally dictated by the size of the video storage media. Video is often stored on a Compact Disc (CD), and a video player for playback of video CDs must be at least large enough to contain a CD. This size limits easy portability of a video CD player. As it becomes easier to obtain video files from the Internet, the need for a portable device capable of storing and playing back MPEG files increases. Therefore, it is desirable to provide such a device for audio and video playback.

### SUMMARY OF THE INVENTION

From the foregoing it may be appreciated by those skilled in the art that a need has arisen for an apparatus that permits audio and video playback. In accordance with the present invention, a device for audio and video playback is provided that substantially eliminates or greatly reduces disadvantages and problems associated with conventional audio and video playback devices.

According to an embodiment of the present invention, there is provided a device for audio and video playback. The device comprises a plurality of input connector ports operable to receive digital audio and video data, analog video signals, and analog audio signals. The device further comprises a storage device operable to electronically store audio and video data in a compressed format such as Moving Picture Experts Group (MPEG) and a plurality of output connector ports operable to provide video and audio output. The device further comprises a central processing unit operable to receive digitized signals from the input connector ports, compress the input signals into MPEG format, store the compressed data in the storage device, retrieve stored data from the storage device, decompress the data, and provide output signals to the output connector ports.

The present invention provides various technical advantages over conventional devices for audio and video playback. For example one technical advantage is to provide a device capable of playback of audio and video files that are electronically stored in a compressed format in a re-writable device. Another technical advantage is to provide a device capable of playback of audio and video files as they are being downloaded from the Internet by a personal computer. Yet another technical advantage is to provide a device capable of playback of audio and video files from either an analog or digital source. Other technical advantages may be readily ascertainable by those skilled in the art from the following figures, description, and claims.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 illustrates a simplified diagram of an audio and video playback device environment in accordance with one embodiment of the present invention;

FIG. 2 illustrates a block diagram of an audio and video playback system.

### DETAILED DESCRIPTION OF THE INVENTION

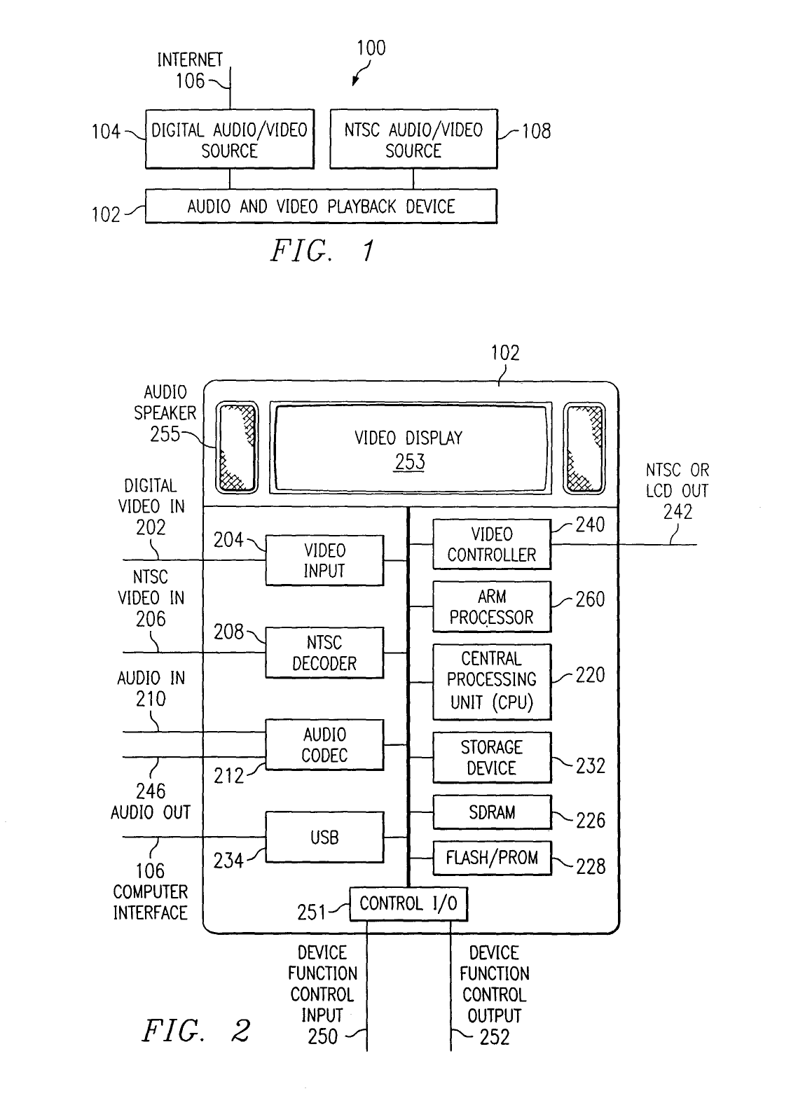

FIG. 1 is a simplified diagram of an audio and video playback environment 100. The environment 100 includes an audio and video playback device 102 that may interface with a variety of input sources. The device 102 is operable to receive digital audio and video data from a digital audio/video source 104. One example of a digital audio/video input source would be a personal computer 104. The personal computer 104 may transfer audio and video files stored in its memory to the device 102. Alternatively, if the personal computer 104 is connected to the Internet 106, audio and video files may be downloaded from the Internet 106 to the personal computer 104 for playback on the audio and video playback device 102. The device 102 is also operable to receive analog video signals such as National Television System Committee-standard (NTSC) video signals from a NTSC video source 108. One example of such an NTSC-format source would be a consumer VCR.

One method for electronically storing digital audio and video signals is to code the signals in one of the Moving Picture Experts Group (MPEG) standard formats. MPEG1 and MPEG4 are likely formats for internet based media due to the amount of time required to download an compressed video. Presently the utility of MPEG1 and MPEG4 videos is limited because they may generally only be viewed directly from a personal computer. This application shows how an audio and video device may playback such files without the need to be attached to a personal computer. Such a device presents many advantages. With a preferred embodiment of the present invention, a user could store MPEG files in the device 102 and playback the files at any convenient time or place. Exemplars of new uses for MPEG-format files would include instructional videos to be viewed at the site where the work is to occur, video tour guides for museums and other attractions, as well as entertainment movies for travelers. The device 102 could also be connected to the video and audio output of a Digital Video Disk (DVD) player for real time capture and compression of the video and audio data stream. In such an application the data stream might be first partially compressed and later fully compressed as desired to minimize the amount of space required for storage in the storage device 232.

FIG. 2 illustrates a block diagram of the audio and video playback device 102. The device is comprised of a device function control input 250 and device function control output 252 provided by a control Input/Output (I/O) unit 251. The control input 250 enables the device user to control the operation of the device 102, for instance, by controlling such playback functions as selecting the file to be viewed, initiating playback, or terminating playback. The control output 252 enables the device 102 to communicate its status or file information to the device user. The device 102 is further comprised of sufficient Programmable Read Only Memory (PROM) or Flash 228 to initialize device 102. Device 102 also includes Synchronized Dynamic Random Access Memory (SDRAM) 226 in such quantities and configurations as to permit the device 102 to properly function. In a preferred embodiment of the claimed invention, digital audio and video signals are buffered in the SDRAM 226 prior to compression by the CPU 220 and storage in the storage device 232. In a preferred embodiment compressed audio and video data to be retrieved from the storage device 232 would first be buffered in the SDRAM 226 before being decompressed by the CPU 220.

The device 102 is further comprised of a plurality of input connector ports. Digital video input signals 202 may be input into the device 102 by the video input interface 204. NTSC or PAL format video signals 206 may be input into the device 102 through the NTSC/PAL decoder interface 208. Audio signals 210 may be input into the device 102 through the audio codec interface 212. In a preferred embodiment of the present invention, the audio and video playback device 102 also contains a computer peripheral interface such as a Universal Serial Bus (USB) interface 234. The USB interface 234 permits the device 102 to receive digital audio and video data directly from a personal computer 104 or other network device.

The audio and video playback device 102 is further comprised of a central processing unit (CPU) 220. In a preferred embodiment of the invention, the CPU 220 is comprised of a Digital Signal Processor (DSP) component and a Single Instruction Stream Multiple Data Stream (SIMD) coprocessor. The CPU 220 is operable to receive inputs from the video input interface 204, NTSC/PAL decoder interface 208, audio codec interface 212, and USB interface 234. Upon receiving audio and video input through the interfaces, the CPU 220 is further operable to compress the input into a native format such as MPEG1, MPEG2, or MPEG4. The device 102 is operable to electronically store the MPEG file in a storage device 232 also contained in the playback device 102. In a preferred embodiment of the invention, it is envisioned that the storage device 232 is a disk drive that can store multiple movies and/or MP3 music. When a MPEG file is to be stored in the storage device 232, the CPU 220 stores the file in SDRAM 226. Arm processor 260 is operable to transfer the MPEG file from the SDRAM to the storage device 232. By performing transcoding (decompression in one format and recompression in another) during download, device 102 may play the audio and or video signals in real time or reduce the amount of space needed to store the information in storage device 232.

Upon receiving a request from the device function control input 250 to begin audio and video playback, the arm processor 260 is operable to retrieve a stored compressed file from the storage device 232 and pass it to the SDRAM 226. The CPU 220 is then operable to retrieve the MPEG file from the SDRAM 226. The CPU 220 then passes the video portion of the MPEG file to the video controller 240, from which the video signal 242 may be output. In a preferred embodiment of the present invention, the video controller 240 would output the video signal 242 to an integrated LCD display 253 incorporated into the audio and video playback device 102. Alternatively, the video signal 242 could be output from the video controller 240 to any form of external NTSC/PAL-format or LCD display device. The audio portion of the MPEG file is passed from the CPU 220 to the audio codec interface 212, from which the audio signal 246 may be output. In a preferred embodiment of the invention, the audio codec interface 212 would output the audio signal 246 to an integrated audio speaker 255 incorporated into the device 102. Alternatively, the audio signal 246 could be output from the audio codec interface 212 to any form of external audio speaker.

At some times it may not be desirable to store the audio and video signals in the storage device 232 prior to playback. Therefore, the CPU 220 is operable to receive analog audio and video inputs from the input connector ports, digitize and compress the data. When the CPU 220 has encoded the data, it is further operable to pass the compressed data through the USB interface 234 to a personal computer 104 or to a networking hub with a USB connector for applications such as teleconferencing. This method permits audio and video data to be captured and transmitted by the device 102 in a “streaming” form, wherein the signals are compressed as they are input, without the intermediate step of saving the signals to the storage device 232. Also the function of compressing the signals into MPEG-format may be provided by personal computer 104(or another networked device) wherein personal computer 104 provides the MPEG-format signals directly to device 102 for storage or decompression and playback. In another implementation, portions of the compressing function may be performed by personal computer 104 and device 102 as desired. When data is received from personal computer 104 or another external device in a compressed format other than the supported decompression formats, the device 102 is operable to transcode the data so that the data may arrive compressed in a format that the device 102 may not be capable of decoding in real time. The device 102 first decodes the compressed data and re-encodes it for storage in the storage device 232. Storing the re-encoded data does not necessarily occur in real time, however, so that future playback of the data is possible. When both the processor of personal computer 104 and the CPU 220 of device 102 take part in the transcoding of audio and video signals, such as where computer processor is dedicated to decoding while CPU 220 is dedicated to encoding, the time required to complete a task may be greatly reduced from the time that would be required if only computer processor or CPU 220 were performing the entire encode/decode function (provided the computer peripheral interface or USB 234 can support the higher data rates).

Thus, it is apparent that there has been provided, in accordance with the present invention, a device for audio and video playback that satisfies the advantages set forth above. Although the present invention has been described in detail, it should be understood that various changes, substitutions, and alterations may be readily ascertainable by those skilled in the art and may be made herein without departing from the spirit and scope of the present invention as defined by the following claims.

What is claimed is:

1. A device for audio and video playback, comprising:
a first input connector port operable to receive digital video signals;
a second input connector port operable to receive National Television System Committee-standard (NTSC) or PAL video signals;
a third input connector port operable to receive analog audio signals;
a storage device operable to electronically store audio and video signals in a Moving Picture Experts Group-standard (MPEG) format such as MPEG1, MPEG2, and MPEG4;
a first output connector port operable to provide analog video output;
a second output connector port operable to provide analog audio output;
a processor operable to receive input signals from the input connector ports, compress the input signals into MPEG format, store the signals in the storage device, retrieve stored signals from the storage device, and provide output signals to the output connector ports.

2. The device for audio and video playback of claim 1, wherein the digital video signals are input from a personal computer.

3. The device for audio and video playback of claim 2, wherein the digital video signals are input in MPEG format.

4. The device for audio and video playback of claim 1, wherein the device further comprises a Universal Serial Bus (USB) port that operates to provide an interface with a personal computer.

5. The device for audio and video playback of claim 4, wherein the digital video signals are input from a personal computer through the USB interface.

6. The device for audio and video playback of claim 1, wherein the storage device is a disk drive.

7. The device for audio and video playback of claim 1, wherein the first output connector port is connected to a liquid crystal display (LCD).

8. The device for audio and video playback of claim 1, wherein the first output connector port is connected to a digital display.

9. The device for audio and video playback of claim 1, wherein the first output connector port is connected to a NTSC-standard display.

10. A method for audio and video playback, comprising:
providing a first input connector port operable to receive digital video signals;
providing a second input connector port operable to receive NTSC-format video signals;
providing a third input connector port operable to receive audio signals;
providing a storage device operable to electronically store audio and video signals in MPEG format;
providing a first output connector port operable to provide video output;
providing a second video output connector port operable to provide audio output;
providing a processor operable to receive input signals from the input connector ports, compress the signals into MPEG format, store the signals in the storage device, retrieve stored signals from the storage device, and provide output signals to the output connector ports.

11. The method for audio and video playback from claim 10, further comprising:
the processor receiving input signals in MPEG format from the input connector ports and providing output signals to the output connector ports for audio and video playback.

12. The method for audio and video playback from claim 10, further comprising:
the processor receiving compressed audio and video input signals from the input connector ports, decoding the input signals, providing output signals to the output connector ports for audio and video playback, and re-encoding the signals in MPEG-format for storage in the storage device.

13. The method for audio and video playback from claim 10, further comprising:
the processor retrieving audio and video signals stored in the storage device and providing output signals to the output connector ports for audio and video playback.

14. A method for audio and video playback, comprising:
receiving audio and video information at a portable electronic storage device;
storing the audio and video information in a portable electronic storage device;
retrieving the audio and video information from the portable electronic storage device; and
playing the audio and video information from the portable electronic storage device.

15. The method for audio and video playback of claim 14, wherein the audio and video information is received from a personal computer.

16. The method for audio and video playback of claim 15, wherein the audio and video information is received in MPEG format.

17. The method for audio and video playback of claim 14, wherein the audio and video information is stored in a disk drive.

18. The method for audio and video playback of claim 14, wherein the audio and video information is retrieved from a disk drive.

19. The method for audio and video playback of claim 14, wherein the video information is played on an integrated Liquid Crystal Display (LCD).
